(19) United States
(12) Patent Application Publication
(10) Pub. No.: US 2026/0236590 A1
(43) Pub. Date: Aug. 13, 2026

(54) METHOD AND APPARATUS FOR ENCODING DEVICE HEALTH INFORMATION

(71) Applicant: HUAWEI TECHNOLOGIES CO., LTD., Shenzhen (CN)

(72) Inventors: Arto Niemi, Helsinki (FI); Sampo Sovio, Helsinki (FI)

(73) Assignee: HUAWEI TECHNOLOGIES CO., LTD., Shenzhen (CN)

(21) Appl. No.: 19/552,895

(22) Filed: Feb. 27, 2026

Related U.S. Application Data
(63) Continuation of application No. PCT/EP2023/073725, filed on Aug. 29, 2023.

(51) Int. Cl. G06F 21/57; G06F 11/07; H03M 13/53

(52) U.S. Cl. CPC G06F 21/577; G06F 11/0763; H03M 13/53

(57) ABSTRACT

A method for encoding device health information includes generating a device health vector including one or more integer values representing a health of a corresponding device, where each integer value in the one or more integer values is greater than zero based on one or more corresponding device checks failing, and each integer value in the one or more integer values is equal to zero based on all of the one or more corresponding device checks passing. The method includes determining a first binary tree of sums including a root sum and a plurality of leaf nodes, where the plurality of leaf nodes includes the device health vector, and constructing a first tree vector by selecting one descendent node from each non-zero parent node in the first binary tree of sums. The method includes generating a reduced integer vector including a header followed by the first tree vector.

### CROSS-REFERENCE TO RELATED APPLICATIONS

This application is a continuation of International Application No. PCT/EP2023/073725, filed on Aug. 29, 2023, the disclosure of which is hereby incorporated by reference in its entirety.

### FIELD

The aspects of the disclosed embodiments relate generally to computer security and device health attestation.

### BACKGROUND

Remote attestation is a process by which devices prove the security and configuration state of their software and hardware to relying parties. An attesting party sends information, referred to as attestation evidence (AE), to a verifier where it is verified and audited. The verifier then returns an attestation result to the relying party.

Device health attestation is an emerging approach that seeks to simplify remote attestation by converting AE into a more easily used format referred to as a device health report (DHR). The DHR, typically produced by a verifier, represents the verifier's verdict regarding the AE.

Conventional DHR formats are for the most part text based resulting in significantly larger data sizes than binary formats. Conventional DHR formats often provide insufficient encoding and produce reports requiring significant storage space and transmission bandwidth. Many conventional DHR formats do not allow for addition of detailed health information which is often useful for recovering from fault conditions. Thus, adding the additional information necessary for fault recovery, breaks backward compatibility with existing DHR formats thereby complicating deployment of these advanced solutions.

Thus, there is a need for improved methods and apparatus capable of providing efficient encoding while minimizing the size of resulting DHRs, that can also allow addition of detailed health information while maintaining at least partial backwards compatibility with existing decoders and verifiers. Accordingly, it would be desirable to provide methods and apparatus that addresses at least some of the problems described above.

### SUMMARY

The aspects of the disclosed embodiments are directed to a method and apparatus configured to produce an efficient encoding that minimizes the amount of data that needs to be signed, verified, transmitted, and/or stored. In addition to minimal data size, the encoding methods disclosed herein preserve at least partial backward compatibility with existing decoders and verifiers.

According to a first aspect of the present disclosure, the above and further implementations and advantages are obtained by a method for encoding device health information. The method includes generating a device health vector, where the device health vector includes one or more integer values representing a health of a corresponding device. Each integer value in the one or more integer values has a value greater than zero when one or more corresponding device checks fail, and a value equal to zero when all of the one or more corresponding device checks pass. The method computes a first binary tree of sums, where the first binary tree of sums comprises a root sum and a plurality of leaf nodes, and the plurality of leaf nodes are formed by the device health vector. The method constructs a first tree vector by selecting one descendent node from each non-zero parent node in the first binary tree of sums; generating a reduced integer vector where the reduced integer vector comprises a header followed by the first tree vector. The header comprises the root sum and a length of the device health vector. The method encodes the reduced integer vector to form a compressed device health vector, where the root sum and the length of the device health vector are encoded based on a universal integer code. The first tree vector is encoded based on a recursive integer coding and a first semi-fixed-length code.

In an embodiment of the present disclosure, the root sum is encoded based on a pre-determined fixed-length code. In some embodiments of the present disclosure, the use of a pre-determined fixed-length code may be more advantageous than a universal integer code.

In an embodiment of the present disclosure, the method further comprises determining an upper bound of the root sum; and encoding the root sum based on the upper bound and a bounded semi-fixed-length code. This property of recursive integer encoding minimizes the size of the resulting compressed data by selecting shorter codewords for nodes nearer the leaf nodes.

In an embodiment of the present disclosure, a first integer value in the compressed device health vector is zero when the corresponding device is healthy and non-zero when the corresponding device is not healthy. This provides backward compatibility with existing encodings that also use a zero value to indicate a healthy condition.

In an embodiment of the present disclosure, the first semi-fixed length code comprises one or more of a mid-truncated semi-fixed length coding, and an end-truncated semi-fixed length coding. The ability to employ a variety of semi-fixed-length codes provides flexibility to tailor implementations for certain applications.

In an embodiment of the present disclosure, the universal integer code comprises one or more of an Elias gamma code, an Elias delta code, an exponential-Golomb code, a Fibonacci code, a Goldbach code, and an Elias omega code. The ability to employ a variety of universal integer codes provides flexibility which may prove useful in when tailoring implementations for certain applications.

In an embodiment of the present disclosure, a bit-length used to encode a descendent node in the tree vector is determined based on a value of the corresponding parent node. Selecting the bit-length based on the parent allows successively shorter bit-lengths to be used for nodes nearer the leaf nodes.

In an embodiment of the present disclosure, the recursive integer coding comprises an interpolative coding. Interpolative coding is a well understood form of recursive integer coding and can therefore provide advantages for certain applications.

In an embodiment of the present disclosure, the one descendent node comprises one of a left child node and a right child node, and wherein the selecting one descendent node is performed in one of a breadth first order and a depth first order. Flexibility regarding how the binary tree of sums is traversed can lead to beneficial alternative implementations.

In an embodiment of the present disclosure, the step of computing the binary tree of sums and the step of constructing the tree vector are performed in an interleaved fashion. Interleaving these steps can provide economies during execution that can reduce computing resources such as memory consumption and processing time.

In an embodiment of the present disclosure, the method further includes: generating one or more diagnostic vectors, where each diagnostic vector in the one or more diagnostic vectors includes additional device health information associated with a corresponding value in the device health vector; generating an expansion point vector, wherein each value in the expansion point vector associates a value in the device health vector with a corresponding diagnostic vector in the one or more diagnostic vectors; computing a second binary tree of sums comprising a second root node and a second plurality of leaf nodes, where the second plurality of leaf nodes comprises a first diagnostic vector in the one or more diagnostic vectors, and the second root node corresponds to a leaf node in the first binary tree-of-sums. The method constructs a second tree vector by selecting one descendent node from each non-zero parent node in the second binary tree of sums; generating a second reduced integer vector comprising a length of the second diagnostic vector and the second tree vector; encoding the second reduced integer vector to form a compressed binary health vector, where the length of the second diagnostic vector is encoded based on the universal integer code, and the second tree vector is encoded based on the recursive integer coding and the first semi-fixed-length code. These additional method steps provide an efficient encoding that also allows inclusion of additional device health information while maintaining backward compatibility with entities configured to consume only the compressed device health vector.

In an embodiment of the present disclosure, the step of computing the second binary tree of sums and the step of constructing the second tree vector are performed in an interleaved fashion. Interleaving these steps can provide economies during execution which can reduce computing resources such as memory consumption and processing time.

According to a second aspect of the present disclosure, the above and further implementations and advantages are obtained by an apparatus comprising a processor communicatively coupled to a memory wherein the memory comprises program instructions that when executed by the processor cause the processor to perform the method according to any one of the preceding aspects or embodiments.

According to a third aspect of the present disclosure, the above and further implementations and advantages are obtained by a computer program product comprising a non-transitory computer readable media having stored thereon program instructions that when executed by a processor cause the processor to perform the method according to the method of the first aspect.

These and other aspects, implementation forms, and advantages of the exemplary embodiments of the present disclosure will become apparent from the embodiments described herein considered in conjunction with the accompanying drawings. It is to be understood, however, that the description and drawings are designed solely for purposes of illustration and not as a definition of the limits of the present disclosure. Additional aspects and advantages of the present disclosure will be set forth in the description that follows, and in part will be obvious from the description, or may be learned by practice of the present disclosure.

### BRIEF DESCRIPTION OF THE DRAWINGS

In the following detailed portion the present disclosure will be explained in more detail with reference to the example embodiments shown in the drawings, in which like references indicate like elements and:

FIG. 1 illustrates a flow chart of an exemplary method configured to provide efficient encoding of device health information incorporating aspects of the disclosed embodiments of the present disclosure.

FIG. 2 illustrates a pictorial diagram of an exemplary binary tree of sums incorporating aspects of the disclosed embodiments of the present disclosure.

FIG. 3 illustrates a pictorial diagram of depicting an exemplary method for appending additional diagnostic information to an encoded DHR incorporating aspects of the disclosed embodiments of the present disclosure.

FIG. 4 illustrates a reduced integer vector representation of the exemplary health vector with additional diagnostic vectors appended incorporating aspects of the disclosed embodiments of the present disclosure.

FIG. 5 illustrates a flow chart of an exemplary method 500 configured to append additional diagnostic information onto a compressed device health vector incorporating aspects of the disclosed embodiments of the present disclosure.

FIG. 6 illustrates a block diagram of an exemplary computing apparatus incorporating aspects of the disclosed embodiments of the present disclosure.

### DETAILED DESCRIPTION

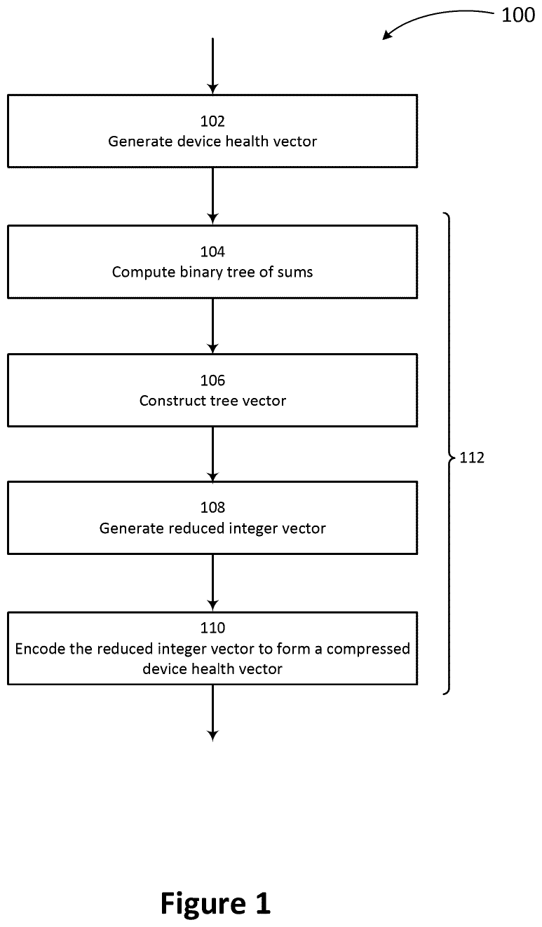

FIG. 1 illustrates a flow chart of an exemplary method 100 configured to provide efficient encoding of device health information in an embodiment of the present disclosure. This exemplary encoding method 100 minimizes the amount of data that needs to be signed by an attestation module, verified against a signature, transmitted over the network, and stored in memory. The resulting minimized data is especially useful when the signing or signature verification is performed within a secure memory, which is often much smaller than a main memory of many general-purpose computing apparatuses.

The exemplary method 100 of the disclosed embodiments of the present disclosure generally includes generation of a device health report (DHR) configured to provide information about the health of a computing apparatus, and compression, also referred to herein as encoding, of the DHR using an efficient encoding process. A novel data formatting scheme allows the device health report to be extended with additional diagnostic and health information while maintaining backward compatibility with existing decoders and verifiers configured to consume the non-extended device health report format. These improvements and advantages are obtained in part by employing a novel data format that is flexible and extensible, then compressing the formatted data using an efficient data compression scheme.

In an embodiment of the present disclosure, a method for encoding device health information includes generating a device health vector, where the device health vector includes one or more integer values representing a health of a corresponding device. Each integer value in the one or more integer values has a value greater than zero when one or more corresponding device checks fail, and a value equal to zero when all of the one or more corresponding device checks pass. The method computes a first binary tree of sums, where the first binary tree of sums comprises a root sum and a plurality of leaf nodes, and the plurality of leaf nodes are formed by the device health vector. The method constructs a first tree vector by selecting one descendent node from each non-zero parent node in the first binary tree of sums; generating a reduced integer vector where the reduced integer vector comprises a header followed by the first tree vector. The header comprises the root sum and a length of the device health vector. The method encodes the reduced integer vector to form a compressed device health vector, where the root sum and the length of the device health vector are encoded based on a universal integer code. The first tree vector is encoded based on a recursive integer coding and a first semi-fixed-length code.

The exemplary method 100 is especially useful and provides significant advantages when employed to facilitate device health attestation in a remote attestation scheme. The term remote attestation (RA), as used to herein, refers to a process in which a device generates cryptographically verifiable evidence, referred to as attestation evidence (AE), regarding the security and configuration state of its hardware and software. The AE typically includes information such as identities of boot-loaders, operating systems (OS) kernel, and an integrity of the OS state. The AE is generated by a trustworthy mechanism, such as within a trusted execution environment or other trusted computing environment executing within the device, thereby making it more difficult for an attacker to compromise the AE than it would be to compromise the attested components themselves. Unfortunately, AE often requires considerable storage space and transmission bandwidth, and can be difficult to parse and evaluate.

Device health attestation (DHA) is an emerging technology that aims to simplify remote attestation by converting AE into a more digestible format referred to as a device health report (DHR). The DHR is produced by an entity referred to as a verifier and represents the verifier's verdict regarding the AE. In contrast to the AE, the DHR typically does not contain the attestation claims themselves. DHA is gaining popularity, and leading companies are beginning to deploy their own DHA solutions and make them available in commercial devices. It should be noted that in certain scenarios the entity that generates the DHR may be on the same physical device as the attester, or the attester itself may directly produce a DHR.

A DHR typically includes an overall verdict of device health but does not usually provide diagnostic information. A DHR may for example indicate that a problem exists with the integrity of the system software running on the device. The DHR may provide coarse-grained details about a problem, such as failure of an integrity verification of the OS system call table. However, a DHR typically does not include detailed diagnostic information, such as which system call table entries failed the integrity check. This more detailed diagnostic information is proving to be very useful in many situations. For example, detailed diagnostic information is useful when deciding whether a device can be reverted back to a known-good configuration, or whether it is so deeply compromised that injecting and loading a recovery image is not possible. Diagnostic information also allows prediction and prevention of future attacks by providing information on which device components are the prime target for attacks and which components are rarely attacked. Additional diagnostic information can also be analysed by machine learning technologies to automatically detect common attack patterns and to develop mitigation strategies.

Conventional DHR formats are often text-based relying on cumbersome formats such as Extensible Markup Language (XML) and JavaScript Object Notation (JSON). These text-based formats often result in reports that are an order of magnitude larger than binary formats.

Referring once again to the flow chart of FIG. 1, the exemplary method 100 generates 102 a device health vector, wherein the device health vector includes one or more integer values representing a health of a corresponding device, and wherein each integer value in the one or more integer values has a value greater than zero when one or more corresponding device checks fail, and a value equal to zero when all the one or more corresponding device checks pass. As used herein, the terms vector and integer vector are used to describe an ordered set of one or more integer values. When used to represent device health information, such as when a DHR is represented by a device health vector, each of the one or more integer values is non-negative, and an integer value of zero represents a healthy condition while an integer value greater than zero represents an unhealthy condition. In an embodiment of the present disclosure, an integer value greater than zero may be employed to provide a number of tests or device checks that have failed. As will be discussed further below, each position in the device health vector may be reserved for certain device health checks or group of device health checks as desired.

In today's connected environment, a variety of devices are interconnected via the internet with various technologies, often referred to as the Internet of Things (IoT). Many of these connected devices are small sensors or other low-cost devices having limited computing resources. To ensure device health attestation is available on these devices it can be beneficial to compress the DHR and thereby minimize the amount of data that needs to be cryptographically signed, verified, stored in memory, or transmitted over a network.

The exemplary method 100 employs an efficient encoding method 112, referred to herein as recursive integer encoding or recursive range encoding, to reduce the size of a DHR. Encoding begins by computing 104 a binary tree of sums. As used herein the term binary tree of sums refers to a binary tree of pairwise sums with the device health vector as the leaves or leaf nodes of the tree. The binary tree of sums concludes with a root node whose value represents a sum of the leaves and is referred to herein as a root sum. Computation 104 of the binary tree of sums may be viewed conceptually as an iterative process where pairwise sums of the leaf nodes are computed to form a first level integer vector. Elements of the first level integer vector may be referred to as intermediate nodes of the binary tree of sums. The first level integer vector will have half as many elements as the device health vector. Taking pairwise sums of the first level integer vector yields a second level integer vector. This process is repeated until a vector having only a single element, the root node, is reached.

Each leaf node of the binary tree of sums corresponds to one integer in the device health vector. With the exception of the leaf nodes, which have no descendent nodes, each node in the binary tree of sums is a parent node and has two descendent nodes, and the value of each parent node represents the sum of its two descendent nodes. As used herein the term “descendent node” refers to one of the two direct descendent nodes of a parent node and is sometimes referred to as a child node. The terms descendent and child are used interchangeably herein to refer to a direct descendent of a parent node.

The device health vector is an integer vector where each position in the vector represents the result of a particular device check or group of device checks. It is therefore important to maintain the position of each value within the device health vector. To achieve this, when selecting descendent nodes for inclusion in the tree vector it is important to select nodes in a fashion that allows the decoder to determine the proper ordering of the device health vector. For example, in an embodiment of the present disclosure, the left child node is selected. In an embodiment of the present disclosure, order may be maintained by selecting the right child node.

Recall that a successful health check is represented within the device health vector by a zero value. Therefore, it can be expected that during normal operation most if not all of the values in the device health vector will have a zero value, and a completely healthy device may be represented with a single zero valued integer.

In a binary tree, all nodes in a sub-tree, such as subtree 222, depending from a parent node having zero value, such as node 226, will also have a zero value. Thus, the zero subtree 222 can be recreated by a decoder based only on the zero-value parent node 226, and there is no need to include any nodes from the all zero subtree 222 in the tree vector. The tree vector is constructed 106 by selecting one descendent node or child node from each non-zero parent node in the binary tree of sums 200. The other or not selected descendent node may be determined during decoding based on the parent node and the selected descendent node.

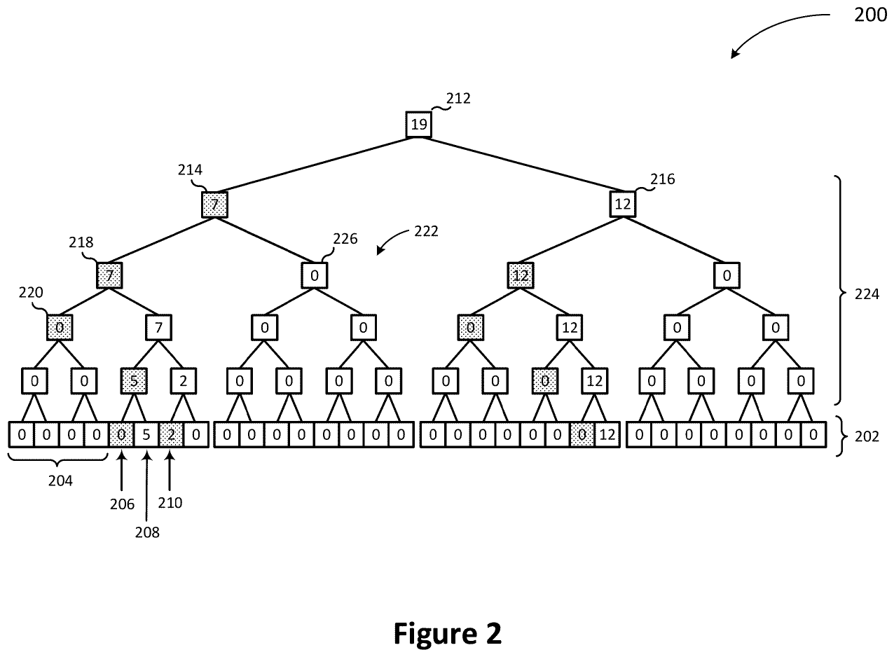

During construction 106 of the tree vector, the binary tree of sums is traversed beginning at the root sum and proceeding in a pre-determined order through each level of the tree. The binary tree of sums may be traversed in either a breath first order, as will be illustrated below and with reference to FIG. 2. In an embodiment of the present disclosure, it may be beneficial to traverse the binary tree of sums in a depth first order.

During decoding, reconstructing of the binary tree of sums, and ultimately the device health vector requires, in addition to the tree vector, knowledge of the root sum and the length of the device health vector. Note that the leaf count of the binary tree of sums is equal to the length of the device health vector. To facilitate reconstruction of the device health vector, the exemplary method 100 generates 108 a reduced integer where the reduced integer vector includes a header followed by the first tree vector, where the header includes the root sum and a length of the device health vector. In an embodiment of the present disclosure, it may be beneficial to place the root sum first in the header followed by the length of the device health vector. Placing the root sum first allows a verifier, that may not understand the full device health vector, to identify a healthy device simply by examining the first integer value in the device health vector. In an embodiment of the present disclosure, it may be advantageous to place the length of the device health vector first in the header followed by the root sum.

As a final step in the compression the exemplary method 100 encodes 110 the reduced integer vector to form a compressed device health vector. The compressed device health vector includes the root sum and length of the device health vector encoded based on a universal integer code, followed by the first tree vector encoded based on a recursive integer coding and a first semi-fixed-length code.

The term “universal integer code” as used herein refers to a type of prefix code that maps the non-negative integers onto binary codewords. In the field of data compression, the term “universal integer code” may sometimes be used to describe a narrower type of prefix code that maps only the positive integers onto binary codewords. However, those skilled in the art will readily recognize that the narrower interpretation is easily expanded to cover the full set of non-negative integers by shifting the initial integer value by one and shifting back upon decoding. Examples of universal integer codes appropriate for use in the exemplary method 100 include an Elias gamma code, an Elias delta code, an exponential-Golomb code, a Fibonacci code, a Goldbach code, and an Elias omega code.

In an embodiment of the present disclosure, encoding 110 of the reduced integer vector includes encoding the root sum based on a pre-determined fixed length code. The bit-length of the fixed-length code used to encode the root sum can be chosen so that it matches the bit-length of a bitmap that has been encoded using an existing DHR encoding method. For example, the root sum could be encoded using thirty-two (32) bits so it matches the bit-length of a typical computer word. Matching the bitlength of an existing DHR encoding method provides backward compatibility with a large class of decoders and verifiers that have been programmed to make a binary healthy/unhealthy determination based on the first decoded integer value.

In an embodiment of the present disclosure, it is possible to determine an upper bound for the root sum. When this is possible, once an upper bound is determined, the root sum may be encoded using a simi-fixed-length code with a bit-length selected based on the determined upper bound of the root sum. Determining the bit-length during encoding can, in an embodiment of the present disclosure, provide improved compression of the resulting binary data.

Improved compression of the reduced integer vector may be achieved by exploiting properties built into the tree vector during construction 106. In a binary tree of sums, each child node is bounded by, i.e., has a value less than or equal to, the value of its parent. During construction 106 of the tree vector, the binary tree of sums is traversed from the root node toward the leaf nodes. By selecting a bit length for encoding a child node based on the value of its parent, successively shorter codewords may be used as encoding approaches the leaf nodes. This use of successively shorter codewords is referred to herein as recursive integer encoding or recursive range encoding.

Interpolative encoding is similar to the more general recursive integer encoding described above and was first developed for use on sorted lists of integer values such as the sorted lists used by indexing applications. In an embodiment of the present disclosure, it may be advantageous to implement the recursive integer encoding portions of the exemplary method 100 based on interpolative encoding techniques.

Several variants of semi-fixed-length codes are available depending on which part of the possible integer range is assigned to the shorter codewords. For example, some alternatives include assigning the shorter codewords to the mid-range integers. In an embodiment of the present disclosure, the shorter codewords may be assigned to the high-range integers. Assignment of the shorter codewords to the mid-range integers is referred to herein as a mid-truncated semi-fixed length coding. Assignment of the shorter codewords to either the high end of the range or low end of the range of integers is referred to herein as an end-truncated semi-fixed-length coding. Selection of the particular variant to be used may, for example, be based on a knowledge of the distribution of integer values to be encoded.

As an aid to understanding the exemplary method 100 illustrated in FIG. 1 describes each of the method steps, such as the steps of computing 104 the binary tree of sums and the step of constructing 106 the tree vector, as separate steps. It should be understood that there is no need or suggestion that one step be fully carried out before the next can be started. In an embodiment of the present disclosure, computational advantages and computational resource economies may be achieved by performing certain steps, such as the steps of computing 104 and selecting 106, together in an interleaved fashion where intermediate results from one step are used in subsequent steps before the prior step has been fully completed. Interleaving the method steps can reduce the amount of computing resources, such as memory and processing time, that are required to produce the tree vector. In an embodiment of the present disclosure, any or all of the listed steps in the exemplary method 100 may be interleaved as desired.

Referring now to FIG. 2 there can be seen a pictorial diagram of an exemplary binary tree of sums 200 incorporating aspects of the disclosed embodiments. The binary tree of sums 200 includes a root node 212, referred to herein as a root sum, and a plurality of leaf nodes 202. The leaf nodes 202 are the only nodes in the binary tree of sums 202 that have no descendent nodes, and each integer value in the device health vector corresponds to an individual one leaf node in the plurality of leaf nodes 202. Intermediate nodes 224 are included in the binary tree of sums 200 to complete a binary tree between the leaf nodes 202 and the root sum 212. With the exception of the leaf nodes 202, each node in the binary tree of sums 200 has two descendent nodes, also referred to herein as child nodes. For example, the parent node 214 has two descendent nodes or child nodes 214 and 216.

The binary tree of sums 200 illustrates one possible example of device health vector 202 that includes thirty-two integers having the following values: (0,0,0,0,0,5,2,0, 0,0,0,0,0,0,0,0, 0,0,0,0,0,0,0,12 0,0,0,0,0,0,0,0). In the illustrated embodiment, each position or integer value in the device health vector 202 is reserved for the results of a certain device check or group of device checks. For example, in one embodiment the first four integers 204 may be reserved for a boot integrity check result, the integer at position five 206 may be reserved for the result of a kernel code integrity check, and the integer at position six 208 may indicate the number of unauthorized system calls in the system call table of the device's OS. Unauthorized in this context may for example refer to when a check of the system call's hash against a whitelist failed to detect a match. In the exemplary device health vector 202, the integer in the sixth position 210 indicates the number of system calls that failed the integrity check.

Construction 106 of the tree vector is accomplished by selecting one descendent node from each non-zero parent node such as selecting the descendent nodes 218 and 220 from the non-zero parent nodes 216 and 218 respectively. The selected nodes are shown in the illustrated binary tree of sums 200 with shading, such as with the shading as shown on the selected node 214. In the illustrated example, the selected one descendent node is the left child node and the binary tree of sums 200 is traversed in a breath first order. Alternatively, the right child node may be selected and when desired the tree may be traversed in depth first order. For all zero subtrees, such as the subtree generally indicated by the numeral 222, none of the child nodes need to be included in the tree vector. All zero subtrees, such as the subtree 222, may be reconstructed during decoding from the zero-parent node 226.

Generating 108 the reduced integer vector is achieved by prepending a header on the tree vector. The header includes the root sum and length of the device health vector, which is also the number of leaf nodes 202 in the binary tree of sums 200. The header values may be included in any desired order. In the illustrated embodiment the root sum is placed first. Placing the root sum first may, in certain environments, provide backwards compatibility with existing devices.

The reduced integer vector is compressed to form a binary data having a minimal number of bits. Table 1, provided below, illustrates encoding of the reduced integer vector as binary codewords. The first column in Table 1 shows the binary codeword used to represent each integer value in the reduced integer vector and the second column provides additional information regarding the encoding. In the illustrated example of Table 1, the first two integer values, the root sum and leaf count, are encoded using the universal Elias Gamma code, which is a specific example of an appropriate universal integer code. The remaining values, which make up the tree vector, are encoded using a recursive integer encoding, and a mid-truncated semi-fixed-length code. The bound, used to select the bit length of the semi-fixed length code for each integer value in the tree vector, is provided in column 2.

TABLE 1
Bitwise Codewords
Reduced integer vector: (19, 32, 7, 7, 12, 0, 0, 5, 0, 0, 2, 0)

| | |
|---|---|
| 111100100 | Root sum: 19, gamma code |
| 11111000001 | Leaf count: 32, gamma code |
| 0111 | 7 <= 19, semi-fixed-length code |
| 111 | 7 <= 7 |
| 1111 | 12 <= 12 |
| 000 | 0 <= 7 |
| 000 | 0 <= 12 |
| 101 | 5 <= 7 |
| 000 | 0 <= 12 |
| 00 | 0 <= 5 |
| 11 | 2 <= 2 |
| 000 | 0 <= 12 |

(50 bits or 7 bytes in total)

In an embodiment of the present disclosure, it may be desirable to include additional diagnostic or health information in an encoded DHR, such as compressed device health vector produced with the above-described exemplary method 100. Including additional diagnostic information in a way that preserves backward compatibility with existing devices, such as existing decoders and verifiers, provides benefits beyond those provided by the information itself.

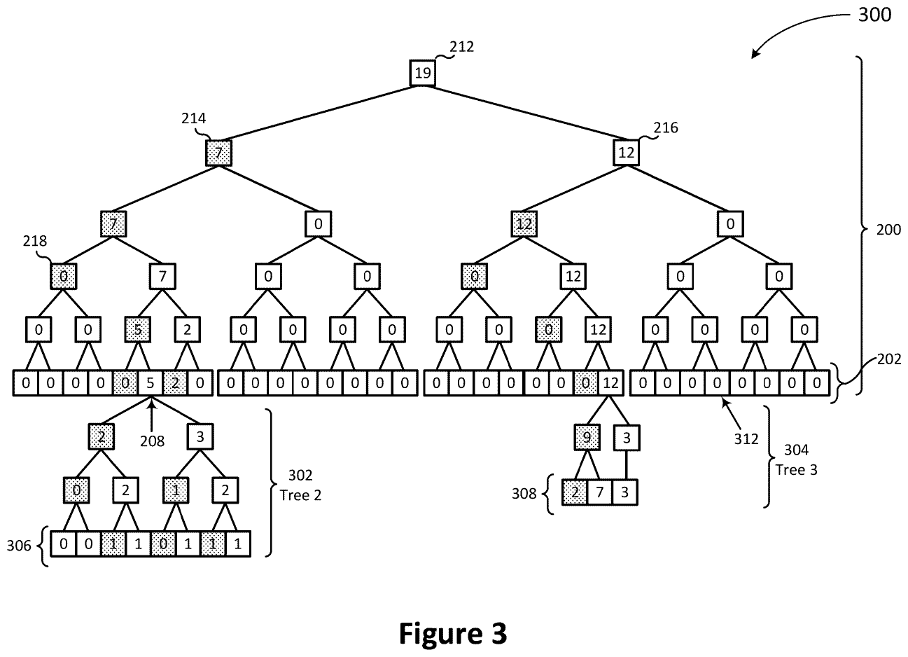

FIG. 3 illustrates a pictorial diagram 300 depicting an exemplary method for appending additional diagnostic information to an encoded DHR incorporating aspects of the disclosed embodiments. As an illustrative example, the above-described encoding of the exemplary diagnostic health vector 202 will be extended with two additional diagnostic vectors 306, 308. Conceptually, inclusion of additional diagnostic vectors may be viewed as attaching sub-trees 302, 304 to corresponding leaves 208, 312 of the binary tree of sums 200. Each of the sub-trees 306, 308 are themselves binary trees of sums computed based on their respective additional diagnostic vectors 306, 308. As will be discussed further below, when including additional diagnostic health vectors, the first binary tree of sums 200 remains unchanged and results in the same compressed device health vector, thereby maintaining backward compatibility with decoders and verifiers that are capable of consuming the compressed device health vector but do not understand the additional diagnostic information.

Continuing with the previous example illustrated in FIG. 2, the sixth integer 208 in the exemplary device health vector 202 corresponds to the number of system calls that failed their integrity check. Knowledge of exactly which system calls failed may be useful when, for example, determining a recovery strategy or developing security enhancements. Results of the integrity checks may be encoded in the exemplary diagnostic vector 306 where each element in the diagnostic vector 306 corresponds to a specific system call, where a value of zero represents a successful integrity check and a value of one indicates the corresponding system call integrity check failed. A second binary tree of sums 302 is computed where the root sum 208 of the second binary tree of sums 302 corresponds to the associated leaf node of the first binary tree of sums 200.

A second additional diagnostic vector 308, corresponding to the twenty-fourth entry in the exemplary health vector 202, is included in the example depicted in FIG. 3. In preparation for encoding, a third binary tree of sums 304 is computed for the second additional diagnostic vector 308. Note, diagnostic vectors having an odd number of elements, such as the exemplary diagnostic vector 308, may be padded with zeros when desired to facilitate computation of the corresponding binary tree of sums.

A tree vector is constructed for each of the sub-trees 302, 304, using a process similar to that described above, where each tree vector includes one descendent node from each non-zero parent node in the corresponding sub tree 302, 304. Decoding of a tree vector to recover the corresponding diagnostic vector requires knowledge of the root sum and length of the additional diagnostic vector. The root sum is available in the diagnostic health vector, so the leaf count, which is also the length of the diagnostic vector, and tree vector are required in the appended data.

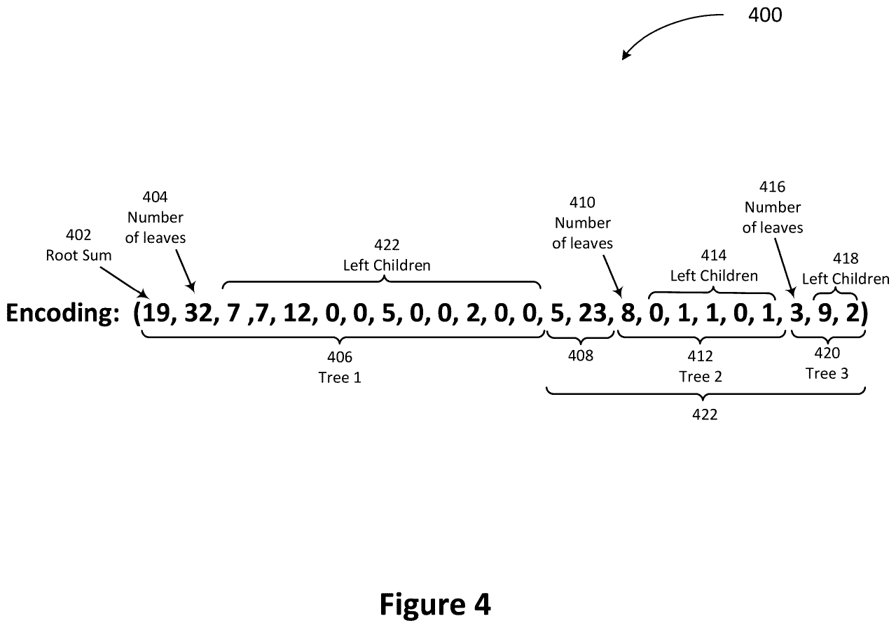

FIG. 4 illustrates a reduced integer vector representation 400 of the exemplary health vector 406 with additional diagnostic vectors 412, 420 appended incorporating aspects of the disclosed embodiments. The integer representation 400 corresponds to the example described above and with reference to FIG. 3. The integer representation 400 begins with an encoding 406 of the first binary tree of sums 200 which, as described above, begins with the root sum 402 and number of leaves 404 of the exemplary binary tree of sums 200, followed by the selected left children 422.

A list of node indexes from which each of the encoded diagnostic sub trees 412, 420 depends is appended to the encoded first tree 406. In the illustrated embodiment, the expansion point vector 408 includes two indexes where the first index, having a value of 5, is the index of the sixth element of the device health vector, and the second value, having the value of 23, is the index of the twenty-fourth element of the device health vector. The expansion point vector 408 is followed by an encoding of each diagnostic sub-tree 412, 420 in the order they appear in the expansion point vector 408. The root sum of each diagnostic sub-tree 412, 420 is will be available from the decoded diagnostic health vector 202, so there is no need to repeat it when encoding each sub tree 412, 420. Therefore, encoding of each diagnostic sub-tree begins with a leaf count 410, 416, followed by the selected left children 414, 418 of the respective diagnostic sub-trees 412, 420.

Finally, the integer representation of the additional diagnostic vectors 422 is encoded as binary codewords. Table 2, provided below, shows an exemplary binary coding of the additional diagnostic vectors 306, 308 as represented by the integer values 422. The first column shows binary codewords generated for each integer value, with notes about the encoding given in the second column. Encoding of the additional diagnostic vectors begins by coding the expansion point vector, which provides indices (5, 23) of each expanded leaf node 208, 312. Integer values in the expansion point vector are encoded using a universal integer code which in the illustrated example is a Gamma code.

TABLE 2
Additional DHR Bitwise Codewords

| | Gamma encoded expansion point vector (5, 23) |
|---|---|
| 11010 | Leaf index 5 |
| 111101000 | Leaf index 23 |
| | Tree 2: (0, 1, 1, 0, 1) |
| 111001 | Gamma coded leaf count: 8 |
| 100 | 2 <= 5 |
| 0 | 0 <= 2 |
| 10 | 1 <= 2 |
| | Tree 3: (9, 2) |
| 11000 | Gamma coded leaf count: 3 |
| 1100 | 9 <= 12 |
| 010 | 2 <= 9 |

(47 bits or 6 bytes in total)

The leaf count or length of each additional diagnostic vector is encoded using a universal integer code, which in the example illustrated in Table 2 is a Gamms code. Elements of each tree vector 412, 420 are encoded using a recursive integer encoding where integer values are encoded using a semi-fixed-length code and a bit-length of the semi-fixed-length code is determined based a value of the corresponding parent node. The integer value and corresponding bound for each value in the tree vectors are given in column 2 of table 2.

Table 3, provided below, shows the final binary encoded compressed device health vector with the appended additional diagnostic data produced for the above-described example. Note: commas are added to data in Table 3 to aid readability and are not present in the actual binary data.

TABLE 3
Resulting encoded device health vector
and additional diagnostic vectors

Device health vector: 0, 0, 0, 00, 5, 2, 0, 0, 0, 0, 0, 0, 0, 0, 0, 0, 0, 0, 0, 0,
0, 0, 12, 0, 0, 0, 0, 0, 0, 0, 0
Compressed device health vector (50 bits-7 bytes): 111100100,
11111000001, 0111, 111, 1111, 000, 000, 101, 000, 00, 11, 000
Additional diagnostic vectors:
index 5 (0, 0, 1, 1, 0, 1, 1, 1)
index 23 (2, 7, 3)
Final compressed additional diagnostic data (47 bits-6 bytes):
11010, 111101000, 111001, 100, 0, 01, 10, 0, 10, 11000, 1100, 010

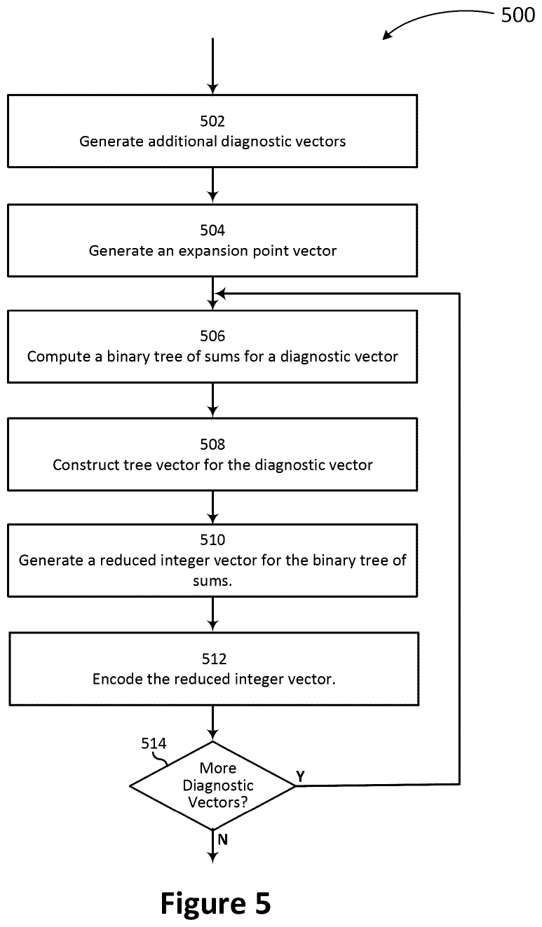

FIG. 5 illustrates a flow chart of an exemplary method 500 configured to append additional diagnostic information to a compressed device health vector incorporating aspects of the disclosed embodiments. The exemplary method 500 of the disclosed embodiments is appropriate for adding additional diagnostic or other device health information to a compressed device health vector such as the compressed device health vector generated by the exemplary method 100 described above and with reference to FIG. 1.

The exemplary method 500 begins by generating 502 one or more diagnostic vectors, where each diagnostic vector in the one or more diagnostic vectors includes additional device health information associated with a corresponding value in the device health vector. Any desired diagnostic or health information may be advantageously employed where the desired health information is represented with one or more integer values incorporated into the one or more diagnostic vectors. Each additional diagnostic vector provides information corresponding to one check or group of checks as indicates by a value in the device health vector. Similar to conventions used by the device health vector, a healthy condition is represented in a diagnostic vector by a zero value and an unhealthy condition is represented by a value greater than zero.

An expansion point vector is generated 504 wherein each value in the expansion point vector represents an index that associates a value in the device health vector with a corresponding one diagnostic vector in the one or more diagnostic vectors. In an embodiment of the present disclosure, the expansion point vector includes a zero-based index value to identify positions in the device health vector. Each value in the expansion point vector is converted to binary using any suitable universal integer coding. The binary encoded expansion point vector is then appended to the compressed device health vector.

Each of the one or more diagnostic vectors is then encoded and appended to the final binary data in the order they appear in the expansion point vector. For each diagnostic vector, a binary tree of sums is computed 506 where the binary tree of sums includes a root node and a plurality of leaf nodes, and the plurality of leaf nodes corresponds to the values in the diagnostic vector.

A diagnostic tree vector, also referred to herein as a second tree vector, is constructed 508 from the generated 506 binary tree of sums by selecting one child node from each non-zero parent node in the corresponding binary tree of sums. When constructing 508 a diagnostic tree vector, order is preserved by ensuring the binary tree of sums is traversed in the same order, i.e., breath first or depth first order, and the same descendent node, i.e., the same left or right child node, should be selected as was used when encoding the device health vector.

As discussed above, it may be advantageous to compute 506 the binary tree of sums and construct 508 the tree vector in an interleaved fashion. Interleaving these operations may, in an embodiment of the present disclosure, provide computational advantages.

A reduced diagnostic integer vector, also referred to herein as a second reduced integer vector, is generated 512 for the diagnostic vector, where the reduced diagnostic integer vector includes a length of the diagnostic vector followed by the corresponding diagnostic tree vector. When decoding the reduced diagnostic integer vector, the root sum value may be obtained from the decoded device health vector and need not be included in the reduced diagnostic integer vector.

The second reduced diagnostic integer vector is encoded 512 to form a compressed binary health vector, wherein the length of the second diagnostic vector is encoded based on the universal integer code, and the second tree vector is encoded based on the recursive integer coding and the first semi-fixed-length code as described above and with respect to Table 2. Any appropriate universal integer code may be advantageously employed when encoding the length of the diagnostic vector. The tree vector is encoded based on a recursive integer encoding and a semi-fixed-length code, where the bit length of the semi-fixed length code for each selected child node is determined based on the value of the corresponding parent node.

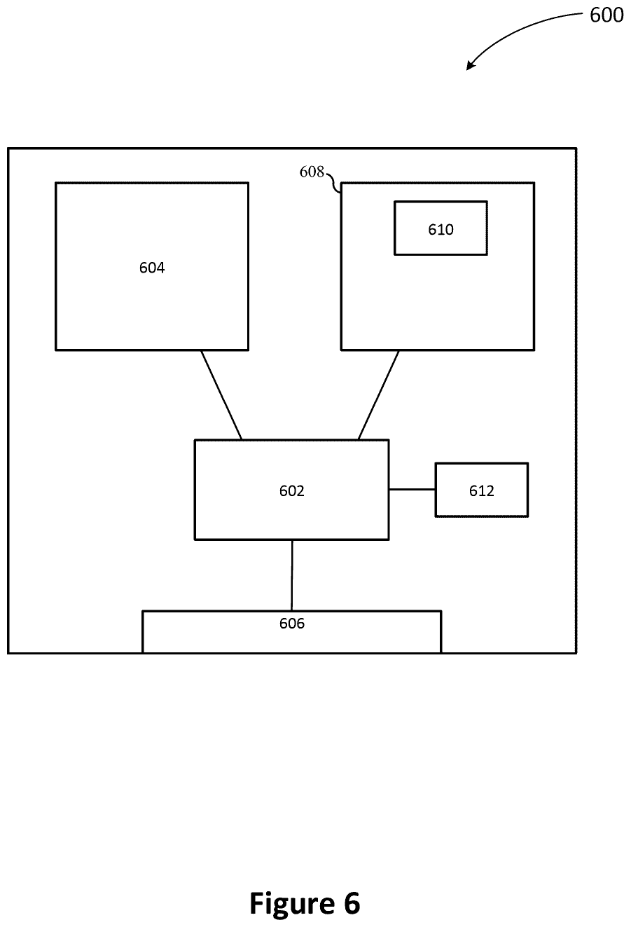

FIG. 6 illustrates a block diagram of an exemplary computing apparatus 600 incorporating aspects of the disclosed embodiments. The exemplary apparatus 600 is appropriate for performing the exemplary method 100 described above and with reference to FIGS. 1 through 5. The efficient encoding and minimal resulting data set size produced by the exemplary method 100 reduces computing resource requirements thereby allowing small and low-cost computing apparatus to be employed for the exemplary computing apparatus 600.

In an embodiment of the present disclosure, the exemplary apparatus 600, includes a processor 602 communicatively coupled to a memory 604 and a network interface 606. The processor 602 is configured to exchange data with other networked computing apparatus via the network interface 606. In an embodiment of the present disclosure, it is beneficial to include a secure execution environment 608 within the apparatus 600 to protect sensitive algorithms and to prevent unauthorized access or modification of confidential information, such as secret key material.

The apparatus 600 may be any desired type of computing apparatus or communications apparatus including but not limited to a mobile communications device such as a smartphone, wearable, or tablet. In an embodiment of the present disclosure, the apparatus 600 may be a personal computing apparatus such as a laptop or other type of personal computing device, a server apparatus such as those used in cloud computing data centers, a small sensor or other Internet of Things (IoT) type device, or any desired computing apparatus that includes a processor a memory and a means for communicating over a computer network.

As is shown in the example of FIG. 6, the processor 602 is communicatively coupled to the memory 604 and is configured to read and perform operations on data stored in the memory 604. In an embodiment of the present disclosure, the apparatus 600 may also include a system storage such as a disk drive or solid-state disk configured to provide high-capacity long term storage capabilities.

The processor 602 can generally comprise any suitable processing device including but not limited to a high-performance multi-core computer processing device such as those used in large cloud computing data centers, a multi-core or single core microprocessor such as those used in workstations and laptop computers, a processing device embedded in a system such as a system on a chip (SoC), or any suitable or specialized processing device such as those used in mobile communications devices, smartphones, phablets, tablet computers, telecommunications equipment, and smart devices such as sensors configured for the internet of things.

The memory 604 may include any desired type or combination of computer accessible memory, such as random-access memory (RAM), read-only memory (ROM), or other suitable types of volatile and non-volatile computer memory.

A network interface 606 is communicatively coupled to the apparatus 600 and is configured to exchange data and messages between the apparatus 600 and other endpoints or nodes in the computer network. The network interface 606 may be any suitable type of computer network configured to allow the apparatus 600, or other computerized device, to share information and resources. The network interface 606 may be adapted to exchange information over any desired type of physical computer network media such as wired, optical, or wireless media, using any desired networking protocol. When operating in a virtualized environment, the network may be adapted to communicate over virtual networks present within the virtualized environment.

Wired networks include any desired type of computer network configured to use electric signals to carry information over network links, such as links constructed of conductive wires. Optical networks include any type of network configured to use optical signals to carry information over network links, such as links constructed of fiberoptic materials. Wireless networks include any suitable type of computer network that uses radio signals to transmit information through air, such as WIFI, Bluetooth, long term evolution (LTE), or other wireless broadband communication mechanisms.

In an embodiment of the present disclosure, the apparatus 600 includes a secure execution environment (SEE) 608, also sometimes referred to as a trusted execution environment (TEE). The SEE 608 may include any desired type of secure execution environment such as a trusted execution environment (TEE), a trusted application (TA), a trusted platform module (TPM), enclave, or other desired type of suitably secure execution environment. For example, as is the case with most new smartphones manufactured today, the apparatus 600 may include an implementation of the ARM® architecture's TrustZone™ TEE.

In an embodiment of the present disclosure, it may be advantageous to include a device health check module 610 configured to perform device health checking operations and produce or validate the integer values representing the results of the device health checks. This device health check module, may, when desired, be protected within the secure execution environment 608, or alternatively it may be implemented as a separate hardware-based module or software module stored within the memory 604.

A codec module 612 may be included in an embodiment of the present disclosure to perform the encoding and decoding required by the exemplary method 100 described above. The codec module 612 may when desired be implemented as a separate hardware-based module or may be included as a software module stored in the memory 604 or protected within the SEE 608.

Thus, while there have been shown, described, and pointed out, fundamental novel features of the present disclosure as applied to the exemplary embodiments thereof, it will be understood that various omissions, substitutions and changes in the form and details of apparatuses and methods illustrated, and in their operation, may be made by those skilled in the art without departing from the spirit and scope of the present disclosure. Further, it is expressly intended that all combinations of those elements, which perform substantially the same function in substantially the same way to achieve the same results, are within the scope of the present disclosure. Moreover, it should be recognized that structures and/or elements shown and/or described in connection with any disclosed form or embodiment of the present disclosure may be incorporated in any other disclosed or described or suggested form or embodiment as a general matter of design choice.

1. A method for encoding device health information, the method implemented by a processor and comprising:
generating a device health vector comprising one or more integer values representing a health of a corresponding device, wherein each integer value in the one or more integer values is greater than zero based on one or more corresponding device checks failing, and each integer value in the one or more integer values is equal to zero based on all of the one or more corresponding device checks passing;
determining a first binary tree of sums comprising a root sum and a plurality of leaf nodes, wherein the plurality of leaf nodes comprises the device health vector;
constructing a first tree vector by selecting one descendent node from each non-zero parent node in the first binary tree of sums;
generating a reduced integer vector comprising a header followed by the first tree vector, wherein the header comprises the root sum and a length of the device health vector; and
encoding the reduced integer vector to form a compressed device health vector, wherein the root sum and the length of the device health vector are encoded based on a universal integer code, and wherein the first tree vector is encoded based on a recursive integer coding and a first semi-fixed-length code.

2. The method according to claim 1, further comprising encoding the root sum based on a pre-determined fixed-length code.

3. The method according to claim 1, further comprising:
determining an upper bound of the root sum; and
encoding the root sum based on the upper bound and a bounded semi-fixed-length code.

4. The method according to claim 1, wherein a integer value in the compressed device health vector is zero when the corresponding device is healthy and non-zero when the corresponding device is not healthy.

5. The method according to claim 1, wherein the first semi-fixed length code comprises one or more of a mid-truncated semi-fixed length coding, and an end-truncated semi-fixed length coding.

6. The method according to claim 1, wherein the universal integer code comprises one or more of an Elias gamma code, an Elias delta code, an exponential-Golomb code, a Fibonacci code, a Goldbach code, and an Elias omega code.

7. The method according to claim 1, wherein a bit-length used to encode a descendent node in the first tree vector is determined based on a value of the corresponding parent node.

8. The method according to claim 1, wherein the recursive integer coding comprises an interpolative coding.

9. The method according to claim 1, wherein the one descendent node comprises one of a left child node and a right child node, and wherein the selecting the one descendent node is performed in one of a breadth first order and a depth first order.

10. The method according to claim 1, wherein determining the first binary tree of sums and constructing the first tree vector are performed in an interleaved fashion.

11. The method according to claim 1, further comprising:
generating one or more diagnostic vectors, wherein each diagnostic vector in the one or more diagnostic vectors comprises additional device health information associated with a corresponding value in the device health vector;
generating an expansion point vector, wherein each value in the expansion point vector associates a value in the device health vector with a corresponding diagnostic vector in the one or more diagnostic vectors;
determining a second binary tree of sums comprising a second root node and a second plurality of leaf nodes, wherein the second plurality of leaf nodes comprises a first diagnostic vector in the one or more diagnostic vectors, and wherein the second root node corresponds to a leaf node in the first binary tree-of-sums;
constructing a second tree vector by selecting one descendent node from each non-zero parent node in the second binary tree of sums;
generating a second reduced integer vector comprising a length of a second diagnostic vector and the second tree vector; and
encoding the second reduced integer vector to form a compressed binary health vector, wherein the length of the second diagnostic vector is encoded based on the universal integer code, and wherein the second tree vector is encoded based on the recursive integer coding and the first semi-fixed-length code.

12. The method according to claim 11, wherein determining the second binary tree of sums and constructing the second tree vector are performed in an interleaved fashion.

13. An apparatus comprising a processor communicatively coupled to a memory comprising program instructions that, when executed by the processor, cause the processor to perform a method comprising:
generating a device health vector comprising one or more integer values representing a health of a corresponding device, wherein each integer value in the one or more integer values is greater than zero based on one or more corresponding device checks failing, and each integer value in the one or more integer values is equal to zero based on all of the one or more corresponding device checks passing;
determining a first binary tree of sums comprising a root sum and a plurality of leaf nodes, wherein the plurality of leaf nodes comprises the device health vector;
constructing a first tree vector by selecting one descendent node from each non-zero parent node in the first binary tree of sums;
generating a reduced integer vector comprising a header followed by the first tree vector, wherein the header comprises the root sum and a length of the device health vector; and
encoding the reduced integer vector to form a compressed device health vector, wherein the root sum and the length of the device health vector are encoded based on a universal integer code, and wherein the first tree vector is encoded based on a recursive integer coding and a first semi-fixed-length code.

14. A computer program product comprising a non-transitory computer readable media having stored thereon program instructions that, when executed by a processor, cause the processor to perform the method comprising:
generating a device health vector comprising one or more integer values representing a health of a corresponding device, wherein each integer value in the one or more integer values is greater than zero based on one or more corresponding device checks failing, and each integer value in the one or more integer values is equal to zero based on all of the one or more corresponding device checks passing;
determining a first binary tree of sums comprising a root sum and a plurality of leaf nodes, wherein the plurality of leaf nodes comprises the device health vector;
constructing a first tree vector by selecting one descendent node from each non-zero parent node in the first binary tree of sums;
generating a reduced integer vector comprising a header followed by the first tree vector, wherein the header comprises the root sum and a length of the device health vector; and
encoding the reduced integer vector to form a compressed device health vector, wherein the root sum and the length of the device health vector are encoded based on a universal integer code, and wherein the first tree vector is encoded based on a recursive integer coding and a first semi-fixed-length code.
